(19) United States
(12) Patent Application Publication
(10) Pub. No.: US 2026/0312050 A1
(43) Pub. Date: Oct. 8, 2026

(54) NEGATIVE ELECTRODE FOR NON-AQUEOUS ELECTROLYTE SECONDARY BATTERY

(71) Applicant: TOYOTA JIDOSHA KABUSHIKI KAISHA, Toyota-shi (JP)

(72) Inventor: Daiki MAEDA, Toyota-shi (JP)

(73) Assignee: TOYOTA JIDOSHA KABUSHIKI KAISHA, Toyota-shi (JP)

(21) Appl. No.: 19/561,896

(22) Filed: Mar. 10, 2026

(30) Foreign Application Priority Data
Apr. 3, 2025 (JP) 2025-062014

(51) Int. Cl. H01M 4/587; H01M 4/133; H01M 4/36; H01M 4/02

(52) U.S. Cl. CPC H01M 4/587; H01M 4/133; H01M 4/366; H01M 2004/027

(57) ABSTRACT

A negative electrode for a non-aqueous electrolyte secondary battery includes a collector, a first active material layer, and a second active material layer in this order. Each of the first active material layer and the second active material layer contains a negative electrode active material. The negative electrode active material contains natural graphite and an Si-based active material. A mass fraction of the Si-based active material in the second active material layer is higher than a mass fraction of the Si-based active material in the first active material layer. An alignment angle of the natural graphite in the second active material layer is larger than an alignment angle of the natural graphite in the first active material layer. The alignment angle indicates an acute angle between a major axis diameter of the natural graphite and a surface of the collector.

### CROSS-REFERENCE TO RELATED APPLICATION

This application claims priority to Japanese Patent Application No. 2025-062014 filed on Apr. 3, 2025. The disclosure of the above-identified application, including the specification, drawings, and claims, is incorporated by reference herein in its entirety.

### BACKGROUND

### 1. Technical Field

The present disclosure relates to a negative electrode for a non-aqueous electrolyte secondary battery.

### 2. Description of Related Art

Japanese Unexamined Patent Application Publication No. 2009-064574 (JP 2009-064574 A) discloses a multilayer structure in which a first negative electrode layer on a side close to a negative electrode collector has artificial graphite and a second negative electrode layer on a side far from the negative electrode collector has natural graphite.

### SUMMARY

Hereinafter, the “negative electrode for a non-aqueous electrolyte secondary battery” may be abbreviated as “negative electrode”. A negative electrode having a multilayer structure is proposed. For example, a proposal is made to dispose artificial graphite in a lower layer on a side close to the negative electrode collector and to dispose natural graphite in an upper layer on a side far from the negative electrode collector. By disposing the natural graphite having relatively favorable charge rate characteristics on a side close to a positive electrode, improvement in charge rate characteristics is expected. However, in addition to the improvement in the charge rate characteristics, improvement in energy density and expansion is also required.

An object of one aspect of the present disclosure is to improve the energy density and the charge rate characteristics of the negative electrode and to reduce the expansion of the negative electrode.

Hereinafter, technical configurations and effects of the present disclosure will be described. However, an action mechanism includes an estimation. The action mechanism does not limit the technical scope of the present disclosure.

1. A negative electrode for a non-aqueous electrolyte secondary battery according to one aspect of the present disclosure includes a collector, a first active material layer, and a second active material layer in this order. Each of the first active material layer and the second active material layer contains a negative electrode active material. The negative electrode active material contains natural graphite and an Si-based active material. A mass fraction of the Si-based active material in the second active material layer is higher than a mass fraction of the Si-based active material in the first active material layer. An alignment angle of the natural graphite in the second active material layer is larger than an alignment angle of the natural graphite in the first active material layer. The alignment angle indicates an acute angle between a major axis diameter of the natural graphite and a surface of the collector.

FIG. 1 is a conceptual sectional view showing a first multilayer structure in the present embodiment. In the drawings of the present disclosure, “NG” indicates natural graphite. “AG” indicates artificial graphite. The negative electrode 20 includes a collector 21, a first active material layer 22a (lower layer), and a second active material layer 22b (upper layer) in this order. In order to improve the charge rate characteristics, a consideration is made to dispose artificial graphite “AG” in the first active material layer 22a and to dispose natural graphite “NG” in the second active material layer 22b.

In order to increase the energy density, the use of the Si-based active material is considered. However, the Si-based active material has significant expansion during charging. The expansion of the Si-based active material may cause the active material layer to collapse. In addition to the introduction of the Si-based active material, measures against the expansion of the Si-based active material are also required.

FIG. 2 is a conceptual sectional view showing a second multilayer structure in the present embodiment. In the drawings of the present disclosure, “Si” indicates the Si-based active material. In order to increase the energy density while alleviating the expansion, for example, a consideration is made to use a mixture of the Si-based active material and a carbon-based active material (artificial graphite, natural graphite). The carbon-based active material is expected to absorb the expansion of the Si-based active material. In the second multilayer structure, the Si-based active material is uniformly distributed to the first active material layer 22a and the second active material layer 22b. In the interface between the first active material layer 22a and the collector 21, the Si-based active material may expand, which may cause interface peeling. The second multilayer structure is considered to be insufficient in the measures against the expansion.

FIG. 3 is a conceptual sectional view showing a third laminated structure in the present embodiment. In the third laminated structure, the Si-based active material is unevenly distributed in the second active material layer 22b. In the third laminated structure, the interface peeling is expected to be reduced. However, in the second active material layer 22b, since the natural graphite cannot sufficiently absorb the expansion of the Si-based active material in an in-plane direction, conductive network between the natural graphite may be destroyed. Further, since the artificial graphite of the first active material layer 22a cannot sufficiently absorb the expansion of the entire second active material layer 22b in the thickness direction, conductive network between the artificial graphite may also be destroyed. As a result, the charge rate characteristics may be impaired. The “in-plane direction” indicates any direction orthogonal to the thickness direction (Z-axis direction). The X-axis direction and the Y-axis direction are examples of the in-plane direction.

FIG. 4 is a conceptual sectional view showing a fourth laminated structure in the present embodiment. In the drawings of the present disclosure, a circular element indicates an unaligned active material. An elliptical element indicates an active material aligned in the thickness direction. In the fourth laminated structure, the natural graphite relatively aligned with the second active material layer 22b is disposed, and the natural graphite not relatively aligned with the first active material layer 22a is disposed. The degree of alignment is evaluated by an alignment angle. As the alignment angle is larger, the active material is considered to be more strongly aligned in the thickness direction. With new findings of the present disclosure, the natural graphite aligned in the thickness direction tends to easily absorb the expansion of the Si-based active material in the in-plane direction. The unaligned natural graphite tends to easily absorb the expansion of the Si-based active material in the thickness direction. The aligned natural graphite and the unaligned natural graphite are expected to synergistically absorb the expansion of the Si-based active material. Further, in the second active material layer, the natural graphite is aligned in the thickness direction, whereby fine pores extending in the thickness direction (vertical direction) along the contour of the natural graphite can be formed. The fine pores are a diffusion path of the electrolytic solution. By forming the fine pores extending in the thickness direction, the curvature can be reduced. By reducing the curvature, further improvement in the charge rate characteristics is expected. In addition, in the first active material layer 22a, the unaligned natural graphite can form the fine pores extending in the in-plane direction. By promoting the lateral and longitudinal diffusion of the electrolytic solution, further improvement in the charge rate characteristics is expected. Therefore, in the fourth laminated structure, the energy density and the charge rate characteristics are expected to be improved and the expansion is also expected to be reduced.

2. The negative electrode for a non-aqueous electrolyte secondary battery according to the “1” may include, for example, the following configuration. Each of the first active material layer and the second active material layer further contains a binder. A mass fraction of the binder in the second active material layer is higher than a mass fraction of the binder in the first active material layer.

In a manufacturing process of the negative electrode, the negative electrode may be subjected to roll pressing. By the roll pressing, the negative electrode active material on the surface of the negative electrode may be tilted laterally, and the alignment angle may be reduced. Since the mass fraction of the binder in the second active material layer is relatively high, the negative electrode active material is expected to be less likely to be tilted. Further, progress of structural destruction due to the expansion of the Si-based active material is expected to be hindered by the relatively high mass fraction of the binder in the second active material layer.

3. The negative electrode for a non-aqueous electrolyte secondary battery according to the “1” or the “2” may include, for example, the following configuration. The negative electrode for a non-aqueous electrolyte secondary battery includes the collector, the first active material layer, a binder layer, and the second active material layer in this order. A mass fraction of the binder in the binder layer is higher than a mass fraction of the binder in the first active material layer and the second active material layer.

Since the mass fraction of the Si-based active material is different between the first active material layer and the second active material layer, a mismatch in expansion and contraction may occur between the first active material layer and the second active material layer. In addition, since the alignment properties of the natural graphite are different between the first active material layer and the second active material layer, a mismatch in the expansion direction and the contraction direction may also occur. The mismatch in the volume change between the layers may cause interlayer peeling between the first active material layer and the second active material layer. The binder layer is expected to absorb the mismatch in the volume change and increase an adhesiveness between the first active material layer and the second active material layer. The interlayer peeling is expected to be reduced by the binder layer.

4. The negative electrode for a non-aqueous electrolyte secondary battery according to any one of the “1” to the “3” may include, for example, the following configuration. The natural graphite in the first active material layer has a bimodal particle size distribution. The natural graphite in the second active material layer has a monomodal particle size distribution.

Since the natural graphite in the second active material layer is a monomodal type, the curvature is expected to be reduced. Since the natural graphite in the first active material layer is a bimodal type, improvement in the energy density and reduction of the expansion are expected.

5. A negative electrode for a non-aqueous electrolyte secondary battery according to one aspect of the present disclosure includes a collector, a first active material layer, a binder layer, and a second active material layer in this order. Each of the first active material layer and the second active material layer contains a negative electrode active material and a binder. A mass fraction of the binder in the binder layer is higher than a mass fraction of the binder in the first active material layer and the second active material layer. The negative electrode active material in the second active material layer substantially consists of the natural graphite and the Si-based active material. The negative electrode active material in the first active material layer substantially consists of the natural graphite. The natural graphite in the first active material layer has a bimodal particle size distribution. The natural graphite in the second active material layer has a monomodal particle size distribution. An alignment angle of the natural graphite in the second active material layer is larger than an alignment angle of the natural graphite in the first active material layer. The alignment angle indicates an acute angle between a major axis diameter of the natural graphite and a surface of the collector.

Hereinafter, an embodiment of the present disclosure (hereinafter, may be abbreviated as “the present embodiment”) will be described. Here, the present embodiment does not limit the technical scope of the present disclosure. The present embodiment is exemplary in all aspects. The present embodiment is not restrictive. The technical scope of the present disclosure includes all changes within the meaning and the scope that are equivalent to the description of CLAIMS. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual sectional view showing a first multilayer structure in the present embodiment;

FIG. 2 is a conceptual sectional view showing a second multilayer structure in the present embodiment;

FIG. 3 is a conceptual sectional view showing a third laminated structure in the present embodiment;

FIG. 4 is a conceptual sectional view showing a fourth laminated structure in the present embodiment;

FIG. 5 is a conceptual sectional view for describing an alignment angle in the present embodiment;

FIG. 6 is a conceptual diagram showing an example of a non-aqueous electrolyte secondary battery in the present embodiment;

FIG. 7 is a graph showing an example of a first particle size distribution in the present embodiment;

FIG. 8 is a graph showing an example of a second particle size distribution in the present embodiment;

FIG. 9 is a conceptual sectional view showing a fifth laminated structure in the present embodiment; and

FIG. 10 is a conceptual sectional view showing a sixth laminated structure in the present embodiment.

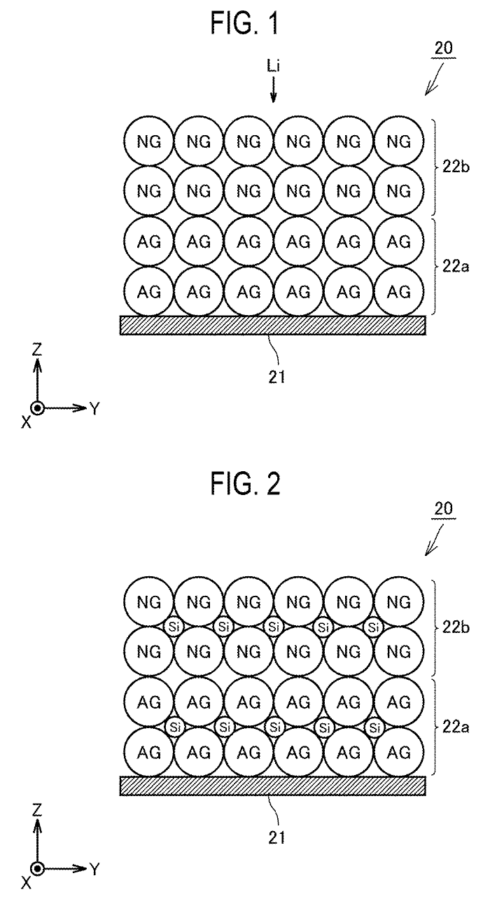

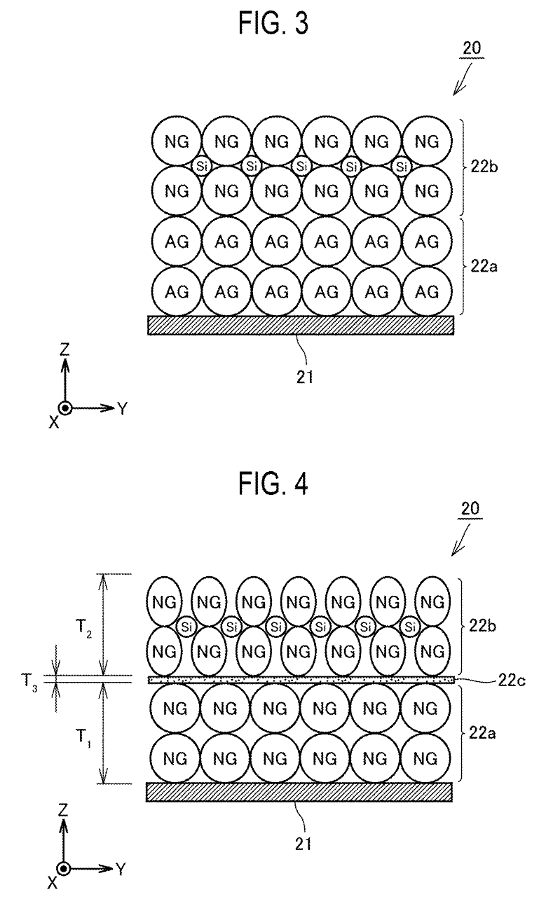

### DETAILED DESCRIPTION OF EMBODIMENTS

### Terms and Phrases

The terms “comprising”, “including”, “having”, and modifications thereof are open-ended expressions. A configuration expressed in an open-ended manner may further include or may not include an additional element in addition to the essential element. The description of “consisting of” is a closed-ended expression. However, even in a configuration expressed in a closed-ended manner, an additional element that is usually an impurity or is irrelevant to the target technology may be included. The description of “substantially consisting of” is a semi-closed-ended expression. In a configuration expressed in a semi-closed-ended manner, addition of an element that does not substantially affect the basic and novel characteristics of the target technology is allowed.

Geometric terms should not be construed in a strict sense. Examples of the geometric terms include “parallel”, “perpendicular”, and “orthogonal”. For example, a direction, an angle, a distance, or the like may be relatively displaced within a range in which substantially the same or similar functions are obtained. The geometric terms may include a tolerance, an error, or the like in design, operation, manufacturing, or the like. The dimensional relationships in each of the drawings may not match the actual dimensional relationships. For the understanding of the reader, the dimensional relationships in each of the drawings may be changed. For example, a length, a width, and a thickness may be changed. Some configurations may be omitted.

Unless otherwise specified, the singular form is not limited to a single (one) element. The singular form also includes a plurality of elements.

The “artificial graphite” indicates graphite synthesized by artificial heat treatment. The artificial graphite is also referred to as synthetic graphite (SG). The “natural graphite” indicates graphite generated in nature. The natural graphite includes flake graphite. The flake graphite may be rounded such that an end of the particle is bent. The “Si-based active material” contains Si (or an Si compound, an Si alloy, or the like) that can be alloyed with Li. The Si-based active material may contain, for example, at least one selected from the group consisting of pure Si, an Si-based alloy, SiO, and Si-C. The “Si-C” indicates a composite particle containing at least one of Si or SiO, and carbon. For example, Si may be supported on the carbon material.

The “particle diameter” is specified by a microscope method. The particle diameter indicates an arithmetic average of a long side and a short side in a minimum bounding rectangle (MBR) of a two-dimensional image of the particle. The “average particle diameter” indicates an arithmetic average of particle diameters of 100 particles randomly extracted. Various image analyses in the present embodiment may be performed by software. For example, “ImageJ” may be used.

The “aspect ratio” indicates a ratio of the long side to the short side of the MBR. An arithmetic average of aspect ratios of 100 particles randomly extracted is adopted.

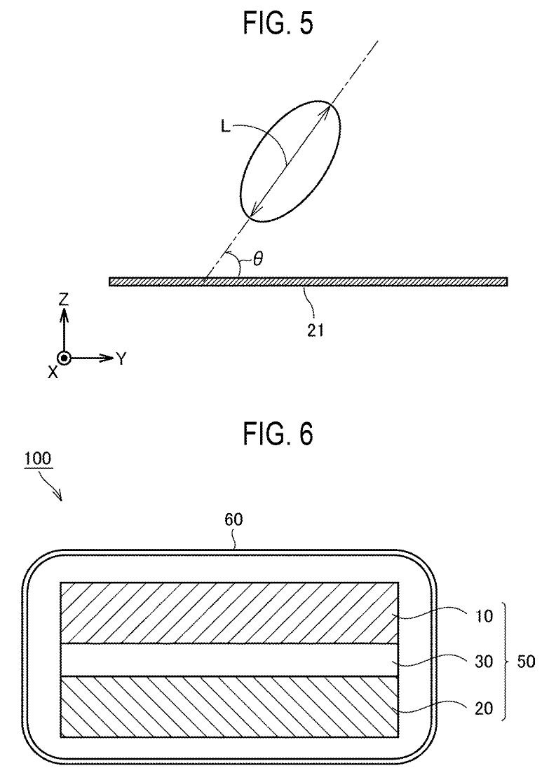

FIG. 5 is a conceptual sectional view for describing an alignment angle in the present embodiment. The “alignment angle” is an acute angle “θ” between the major axis diameter “L” of the particle (for example, the natural graphite) and the surface of the collector 21 in a cross-sectional scanning electron microscope (SEM) image of the negative electrode 20. The alignment angle can take a value of 0° to 90°. The major axis diameter indicates a maximum Feret diameter of the particle. An arithmetic average of alignment angles of 100 particles randomly extracted is adopted.

The “basis weight” indicates a mass per unit area.

The “void ratio” is specified by an image analysis method. The void and the solid are discriminated by binarizing the cross-sectional SEM image of each layer. The void ratio is obtained by dividing the total area (total pixels) of the voids by the area of the entire layer.

The “active material layer” is a general term for the first active material layer and the second active material layer.

### Non-Aqueous Electrolyte Secondary Battery

FIG. 6 is a conceptual diagram showing an example of a non-aqueous electrolyte secondary battery in the present embodiment. The non-aqueous electrolyte secondary battery 100 may include, for example, a power generation element 50 and a case 60. The case 60 accommodates the power generation element 50. The case 60 may be, for example, a container made of metal or a pouch made of an aluminum laminate film. The power generation element 50 may include, for example, a positive electrode 10, a negative electrode 20, a separator 30, and a non-aqueous electrolyte (not shown). The power generation element 50 may be, for example, a wound type or a laminated type. The power generation element 50 may have a monopolar structure or a bipolar structure. The separator 30 can electrically separate the positive electrode 10 from the negative electrode 20. The separator 30 may include, for example, a porous film made of a resin. The non-aqueous electrolyte is an Li ion conductor. The non-aqueous electrolyte may include, for example, an Li salt and an organic solvent. The non-aqueous electrolyte may be, for example, impregnated in the separator 30. The non-aqueous electrolyte may include, for example, a polymer electrolyte, a gel electrolyte, and a solid electrolyte. The solid electrolyte may include, for example, a sulfide solid electrolyte, an oxide solid electrolyte, and a halide solid electrolyte. The positive electrode 10 contains a positive electrode active material. The positive electrode active material may include, for example, a lithium transition metal composite oxide (Li[NiCoMn]O₂) or a lithium phosphate compound (Li[FeMn]PO₄). The description of [NiCoMn], [FeMn], and the like indicates that the total of the compositional ratios of the components in [] is “1”. The compositional ratio of each component is optional as long as the total is 1. For example, the compositional ratio of some components may be zero.

### Negative Electrode

The negative electrode 20 may have a sheet-like shape, for example. The negative electrode 20 has a fourth laminated structure (FIG. 4). The negative electrode 20 includes the collector 21, the first active material layer 22a, and the second active material layer 22b in this order in the thickness direction. The active material layer may be disposed on a part of the surface of the collector 21 or may be disposed on the entire surface. The active material layer may be disposed on only one surface of the collector 21 or may be disposed on both surfaces of the collector 21. The collector 21 may include, for example, a metal foil (a Cu foil, a Ni foil, or the like) or a conductive resin layer. The collector 21 may have a thickness of, for example, 1 μm to 100 μm.

The negative electrode 20 may further include any element as long as the collector 21, the first active material layer 22a, and the second active material layer 22b are included in this order. For example, the negative electrode 20 may include the collector 21, the first active material layer 22a, the binder layer 22c, and the second active material layer 22b in this order. For example, a conductive layer, an adhesion layer (both not shown), or the like may be disposed between the first active material layer 22a and the collector 21. For example, a ceramic particle layer or the like (not shown) may be disposed on the surface of the second active material layer 22b. The ceramic particle layer may include, for example, a heat-resistant ceramic (alumina, boehmite). The negative electrode 20 may include a third active material layer (not shown).

Each layer included in the negative electrode 20 may be, for example, a coating layer. The coating layer indicates a layer formed by applying a coating material. Each coating material may be applied substantially simultaneously or may be applied sequentially. For example, before the coating material is dried, the negative electrode active material included in the coating layer can be aligned in the thickness direction by applying a magnetic field to the coating layer. For example, the alignment angle may be adjusted by the strength of the magnetic field, the concentration of the coating material, the pressing pressure, and the like.

Each layer may have any thickness. For example, a thickness “T₁” of the first active material layer 22a and a thickness “T₂” of the second active material layer 22b may satisfy a relationship of “T₁/T₂= 1/9 to 9/1”, “T₁/T₂ = 2/8 to 8/2”, “T₁/T₂ = 3/7 to 7/3”, or “T₁/T₂ = 4/6 to 6/4”. The thickness “T₁” may be, for example, 10 μm or more, 50 μm or more, 100 μm or more, 200 μm or more, or 500 μm or more. The thickness “T₁” may be, for example, 1 mm or less, 500 μm or less, or 200 μm or less.

Each layer may have any basis weight. For example, a basis weight “W₁” of the first active material layer 22a and a basis weight “W₂” of the second active material layer 22b may satisfy a relationship of “W₁/W₂ = 1/9 to 9/1”, “W₁/W₂ = 2/8 to 8/2”, “W₁/W₂ = 3/7 to 7/3”, or “W₁/W₂ = 4/6 to 6/4”. The basis weight “W₁” may be, for example, 1 mg/cm² or more, 5 mg/cm² or more, 10 mg/cm² or more, or 20 mg/cm² or more. The basis weight “W₁” may be, for example, 50 mg/cm² or less, 30 mg/cm² or less, 25 mg/cm² or less, 15 mg/cm² or less, or 10 mg/cm² or less.

The void ratio of the active material layer may be substantially constant over the entire region. The void ratio of the active material layer may be locally different. For example, the void ratio “φ₁” of the first active material layer 22a may be lower than the void ratio “φ₂” of the second active material layer 22b. That is, a relationship of “φ₁ < φ₂” or “1 < φ₂/φ₁” may be satisfied. The ratio “φ₂/φ₁” may be, for example, 1.2 or more, 1.5 or more, 2 or more, or 2.5 or more. The ratio “φ₂/φ₁” may be, for example, 5 or less, 3 or less, or 2 or less.

### Negative Electrode Active Material

Each of the first active material layer 22a and the second active material layer 22b contains the negative electrode active material. Each of the active material layers may further contain, for example, a conductive material and a binder. The active material layers may each independently contain, for example, in terms of mass fraction, 0% to 10% of a binder, 0% to 10% of a conductive material, and a negative electrode active material as a remainder. The mass fractions of the binder and the conductive material in each of the active material layers may be each independently 0.1% to 3% or 0.5% to 2%.

The negative electrode active material is particulate. The negative electrode active material may have any particle shape. The particle shape may be, for example, spherical, ellipsoidal, or flat. The aspect ratio of the negative electrode active material may be, for example, more than 1, 1.1 or more, 1.2 or more, 1.5 or more, 2 or more, 4 or more, or 6 or more. The aspect ratio of the negative electrode active material may be, for example, 10 or less, 8 or less, 6 or less, 5 or less, or 4 or less.

The negative electrode active material contains natural graphite and an Si-based active material. The negative electrode active material may further include other active materials in addition to the natural graphite and the Si-based active material. The other active materials may include, for example, artificial graphite, lithium titanate, a Sn-based alloy, SnO, pure Li, an Li-based alloy, and the like.

A mass fraction of the Si-based active material with respect to the entire negative electrode active material may be, for example, 1% or more, 3% or more, 5% or more, 10% or more, 15% or more, 20% or more, 25% or more, 30% or more, 40% or more, 50% or more, 60% or more, 70% or more, 80% or more, or 90% or more. The mass fraction of the Si-based active material with respect to the entire negative electrode active material may be, for example, 95% or less, 90% or less, 80% or less, 70% or less, 60% or less, 50% or less, 40% or less, 30% or less, 25% or less, 20% or less, 15% or less, 10% or less, 5% or less, or 3% or less.

The Si-based active material is unevenly distributed in the second active material layer 22b. A mass fraction “M_{2S}” of the Si-based active material in the second active material layer 22b is higher than a mass fraction “M_{1S}” of the Si-based active material in the first active material layer 22a. That is, a relationship of “M_{1S} < M_{2S}” or “1 < M_{2S}/M_{1S}” is satisfied. The ratio “M_{2S}/M_{1S}” may be, for example, 1.2 or more, 2 or more, 5 or more, 10 or more, or 100 or more. The ratio “M_{2S}/M_{1S}” may be, for example, 1000 or less, 100 or less, 10 or less, or 5 or less. The mass fraction “M_{2S}” may be, for example, 1% or more, 3% or more, 5% or more, 10% or more, 15% or more, 20% or more, 25% or more, 30% or more, 40% or more, 50% or more, 60% or more, 70% or more, 80% or more, or 90% or more. The mass fraction “M_{2S}” may be, for example, 95% or less, 90% or less, 80% or less, 70% or less, 60% or less, 50% or less, 40% or less, 30% or less, 25% or less, 20% or less, 15% or less, 10% or less, 5% or less, or 3% or less.

For example, the negative electrode active material in the second active material layer 22b may substantially consist of the natural graphite and the Si-based active material. For example, the negative electrode active material in the first active material layer 22a may substantially consist of the natural graphite.

In the second active material layer 22b, the Si-based active material and the natural graphite may satisfy, for example, a relationship of “Si-based active material/natural graphite = 1/99 to 50/50”, “Si-based active material/natural graphite = 1/99 to 30/70”, “Si-based active material/natural graphite = 1/99 to 20/80”, “Si-based active material/natural graphite = 1/99 to 10/90”, or the like in terms of mass ratio.

The natural graphite is distributed in the first active material layer 22a and the second active material layer 22b. The alignment properties of the natural graphite are different between the first active material layer 22a and the second active material layer 22b. An alignment angle “θ₂” of the natural graphite in the second active material layer 22b is larger than an alignment angle “θ₁” of the natural graphite in the first active material layer 22a. That is, a relationship of “θ₁ < θ₂” is satisfied. The alignment angle “θ₂” may be, for example, 30° or more, 45° or more, 60° or more, or 75° or more. The alignment angle “θ₂” may be, for example, 90° or less, 75° or less, or 60° or less. The alignment angle “θ₁” may be, for example, less than 30°, 15° or less, or 5° or less. The alignment angle “θ₁” may be, for example, 0° or more.

The Si-based active material and the natural graphite may each independently have any average particle diameter. The average particle diameter may be, for example, 1 μm or more, 5 μm or more, 10 μm or more, or 15 μm or more. The average particle diameter may be, for example, 30 μm or less, 20 μm or less, 15 μm or less, or 10 μm or less.

For example, the Si-based active material may be a small particle, and the natural graphite may be a large particle. A ratio “d_{N}/d_{S}” of the average particle diameter “d_{N}” of the natural graphite to the average particle diameter “d_{S}” of the Si-based active material may be, for example, 1 or more, 1.5 or more, 2 or more, 3 or more, 4 or more, or 5 or more. The ratio “d_{N}/d_{S}” may be 10 or less, 8 or less, or 6 or less.

For example, the particle size distributions of the natural graphite may be different between the first active material layer 22a and the second active material layer 22b. The particle size distribution may be based on volume or may be based on the number of particles. In the present embodiment, in the histogram, a convex region having a height of 0.1 times or more the height of the maximum peak is regarded as a peak. The number of peaks may be, for example, 1 or more, 2 or more, or 3 or more. The “monomodal type (also referred to as a unimodal type)” indicates a distribution in which there is substantially one peak. The “bimodal type” indicates a distribution in which there are substantially two peaks. The “multimodal type” indicates a distribution in which there are three or more peaks.

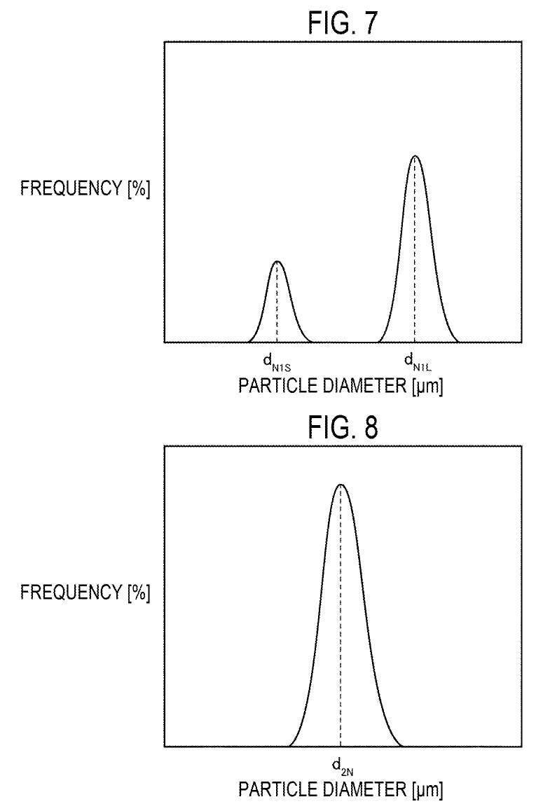

FIG. 7 is a graph showing an example of a first particle size distribution in the present embodiment. The natural graphite in the first active material layer 22a may have the first particle size distribution. The first particle size distribution is a bimodal type. The peak on the side with a large particle diameter has a mode diameter “d_{N1L}”. The “mode diameter (most frequent value)” indicates a particle diameter corresponding to the peak top. The mode diameter “d_{N1L}” may be regarded as an average particle diameter of a large particle group. The peak on the side with a small particle diameter has a mode diameter “d_{N1S}”. The mode diameter “d_{N1S}” may be regarded as an average particle diameter of a small particle group. A size ratio “d_{N1L}/d_{N1S}” in the first active material layer 22a may be, for example, 2 or more, 3 or more, 4 or more, or 5 or more. The size ratio “d_{N1L}/d_{N1S}” may be, for example, 10 or less, 8 or less, or 6 or less.

FIG. 8 is a graph showing an example of a second particle size distribution in the present embodiment. The natural graphite in the second active material layer 22b may have the second particle size distribution. The second particle size distribution is a monomodal type. The peak has a mode diameter “d_{2N}”. The mode diameter “d_{2N}” may be regarded as an average particle diameter of the natural graphite in the second active material layer 22b.

For example, a relationship of “d_{N1S} < d_{2N} < d_{N1L}” may be satisfied between the first particle size distribution (FIG. 7) and the second particle size distribution (FIG. 8). By satisfying the relationship, for example, improvement in the balance between the energy density, the charge rate characteristics, and the expansion is expected.

### Binder

The binder may include, for example, styrene butadiene rubber (SBR), carboxymethyl cellulose (CMC), polyacrylic acid (PAA), or polytetrafluoroethylene (PTFE). The mass fraction of the binder may be substantially constant over the entire region of the active material layer. The mass fraction of the binder may be locally different. For example, the mass fraction of the binder may be different between the first active material layer 22a and the second active material layer 22b. For example, a mass fraction “M_{2B}” of the binder in the second active material layer 22b may be higher than a mass fraction “M_{1B}” of the binder in the first active material layer 22a. That is, a relationship of “M_{1B} < M_{2B}” or “1 < M_{2B}/M_{1B}” may be satisfied. The ratio “M_{2B}/M_{1B}” may be, for example, 1.2 or more, 1.5 or more, 2 or more, or 2.5 or more. The ratio “M_{2B}/M_{1B}” may be, for example, 3 or less or 2 or less.

For example, a binder layer 22c may be provided between the first active material layer 22a and the second active material layer 22b. A mass fraction of the binder in the binder layer 22c is higher than a mass fraction of the binder in the first active material layer 22a and the second active material layer 22b. The binder layer 22c may be a layer that substantially does not contain a negative electrode active material. The binder layer 22c may contain, for example, in terms of mass fraction, 0% to 10% of a conductive material, and a binder as a remainder. A mass fraction of the conductive material in the binder layer 22c may be, for example, 1% to 5%.

For example, the type of the binder may be the same between the layers. For example, the type of the binder may be different between the layers. For example, the binder in the binder layer 22c may include a resin that swells with an electrolytic solution. For example, the binder in the binder layer 22c may include a resin having ion permeability or a resin having ion conductivity. The improvement in the charge rate characteristics is expected by allowing the electrolytic solution and the Li ions to permeate the binder layer 22c. For example, the binder in the binder layer 22c may include a fibrous resin. The fibrous resin may extend to crosslink the first active material layer 22a and the second active material layer 22b. By crosslinking the first active material layer 22a and the second active material layer 22b with the fibrous resin, for example, the improvement in the peel strength is expected. The binder in the binder layer 22c may contain, for example, at least one selected from the group consisting of PAA, polyacrylic acid ester, CMC, alginic acid, polyvinylidene fluoride (PVDF), poly(vinylidene fluoride-co-hexafluoropropylene) (PVDF-HFP), and PTFE. For example, PAA, PVDF, PVDF-HFP, and the like may have swellability, ion permeability, or ion conductivity. For example, PTFE may be fibrous.

A thickness “T₃” of the binder layer 22c may be, for example, smaller than the thickness “T₁” of the first active material layer 22a and the thickness “T₂” of the second active material layer 22b. The thickness “T₃” of the binder layer 22c may be, for example, 10 μm or less, 5 μm or less, or 3 μm or less. The thickness “T₃” of the binder layer 22c may be, for example, 0.5 μm or more, 1 μm or more, or 3 μm or more. A basis weight “W₃” of the binder layer 22c may be, for example, smaller than the basis weight “W₁” of the first active material layer 22a and the basis weight “W₂” of the second active material layer 22b. The basis weight “W₃” of the binder layer 22c may be, for example, 5 mg/cm² or less, 3 mg/cm² or less, or 1 mg/cm² or less. The basis weight “W₃” of the binder layer 22c may be, for example, 0.1 mg/cm² or more or 0.5 mg/cm² or more.

### Conductive Material

The conductive material may include, for example, acetylene black, carbon nanotube (CNT), vapor-grown carbon fiber (VGCF). The mass fraction of the conductive material may be substantially constant over the entire region of the active material layer. The mass fraction of the conductive material may be locally different. For example, the mass fraction of the conductive material may be different between the layers. For example, the type of the conductive material may be different between the layers. For example, the binder layer 22c may include a fibrous conductive material. The binder layer 22c may include, for example, at least one selected from the group consisting of CNT and VGCF. The fibrous conductive material may extend to crosslink the first active material layer 22a and the second active material layer 22b. By crosslinking the first active material layer 22a and the second active material layer 22b with the fibrous conductive material, for example, the improvement in the charge rate characteristics and the reduction of the interlayer peeling are expected.

### Appendix 1

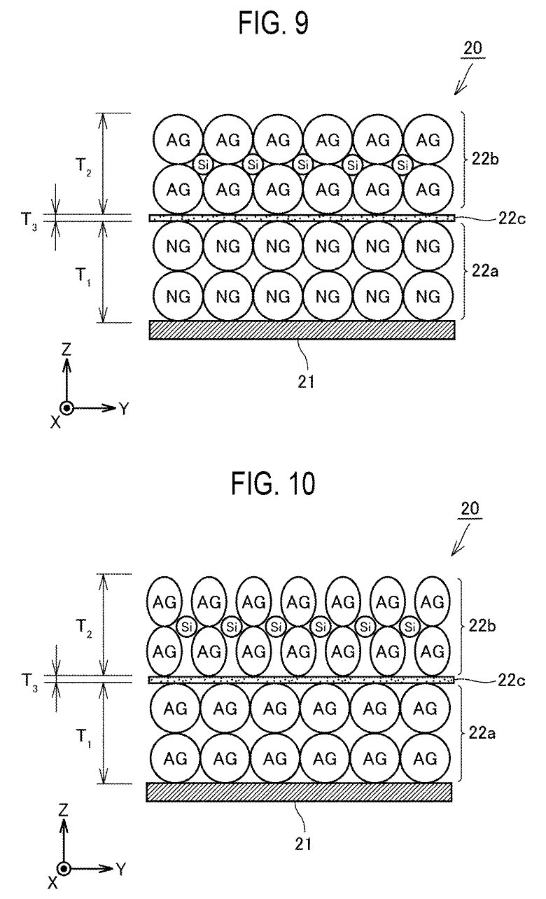

FIG. 9 is a conceptual sectional view showing a fifth laminated structure in the present embodiment.

A negative electrode 20 for a non-aqueous electrolyte secondary battery according to one aspect of the present disclosure includes

a collector 21, a first active material layer 22a, and a second active material layer 22b in this order.

Each of the first active material layer 22a and the second active material layer 22b contains the negative electrode active material.

The negative electrode active material contains natural graphite, artificial graphite, and an Si-based active material.

A mass fraction of the Si-based active material in the second active material layer 22b is higher than a mass fraction of the Si-based active material in the first active material layer 22a.

A mass fraction of the artificial graphite in the second active material layer 22b is higher than a mass fraction of the artificial graphite in the first active material layer 22a.

A mass fraction of the natural graphite in the first active material layer 22a is higher than a mass fraction of the natural graphite in the second active material layer 22b.

The fifth laminated structure (FIG. 9) is a structure in which the aligned natural graphite in the second active material layer 22b of the fourth laminated structure (FIG. 4) is substituted with artificial graphite. In the fifth laminated structure, a negative electrode having high energy density and low expansion is provided. With new findings of the present disclosure, the artificial graphite tends to well absorb the expansion in the in-plane direction. In the fifth laminated structure, the natural graphite of the first active material layer 22a can absorb the expansion of the Si-based active material in the thickness direction, and the artificial graphite of the second active material layer 22b can absorb the expansion of the Si-based active material in the in-plane direction. That is, the expansion of the Si-based active material can be synergistically absorbed. The fifth laminated structure is considered to be more excellent than the first laminated structure to the third laminated structure in terms of the balance between the energy density, the charge rate characteristics, and the expansion. In terms of the charge rate characteristics and the expansion, the fourth laminated structure may be more excellent than the fifth laminated structure. Any element described in the present embodiment can be applied to the fifth laminated structure. In this case, the “aligned natural graphite” is read as “artificial graphite”. For example, the mass fraction of the aligned natural graphite is read as the mass fraction of the artificial graphite.

### Appendix 2

FIG. 10 is a conceptual sectional view showing a sixth laminated structure in the present embodiment.

A negative electrode 20 for a non-aqueous electrolyte secondary battery according to one aspect of the present disclosure includes a collector 21, a first active material layer 22a, and a second active material layer 22b in this order.

Each of the first active material layer 22a and the second active material layer 22b contains the negative electrode active material.

The negative electrode active material contains artificial graphite and an Si-based active material.

A mass fraction of the Si-based active material in the second active material layer 22b is higher than a mass fraction of the Si-based active material in the first active material layer 22a.

An alignment angle of the artificial graphite in the second active material layer 22b is larger than an alignment angle of the artificial graphite in the first active material layer 22a.

The alignment angle indicates an acute angle between a major axis diameter of the artificial graphite and a surface of the collector.

The sixth laminated structure (FIG. 10) is a structure in which the natural graphite in the fourth laminated structure (FIG. 4) is substituted with artificial graphite. In the sixth laminated structure, a negative electrode having high energy density and high charge rate characteristics, and low expansion is provided. The expansion of the Si-based active material in the in-plane direction is expected to be further absorbed by aligning the artificial graphite. Improvement in the curvature is also expected by the aligned artificial graphite. The sixth laminated structure is considered to be more excellent than the first laminated structure to the third laminated structure in terms of the balance between the energy density, the charge rate characteristics, and the expansion. In terms of the charge rate characteristics, the fourth laminated structure may be more excellent than the sixth laminated structure. In terms of the expansion, the fourth laminated structure and the fifth laminated structure may be more excellent than the sixth laminated structure. Any element described in the present embodiment can be applied to the sixth laminated structure. In this case, the “natural graphite” is read as “artificial graphite”. For example, the alignment angle of the natural graphite is read as the alignment angle of the artificial graphite.

What is claimed is:

1. A negative electrode for a non-aqueous electrolyte secondary battery, the negative electrode comprising:
a collector;
a first active material layer; and
a second active material layer, in this order, wherein:
each of the first active material layer and the second active material layer contains a negative electrode active material;
the negative electrode active material contains natural graphite and an Si-based active material;
a mass fraction of the Si-based active material in the second active material layer is higher than a mass fraction of the Si-based active material in the first active material layer;
an alignment angle of the natural graphite in the second active material layer is larger than an alignment angle of the natural graphite in the first active material layer; and
the alignment angle indicates an acute angle between a major axis diameter of the natural graphite and a surface of the collector.

2. The negative electrode according to claim 1, wherein:
each of the first active material layer and the second active material layer further contains a binder; and
a mass fraction of the binder in the second active material layer is higher than a mass fraction of the binder in the first active material layer.

3. The negative electrode according to claim 2, wherein:
the negative electrode includes the collector, the first active material layer, a binder layer, and the second active material layer in this order; and
a mass fraction of the binder in the binder layer is higher than a mass fraction of the binder in the first active material layer and the second active material layer.

4. The negative electrode according to claim 1, wherein:
the natural graphite in the first active material layer has a bimodal particle size distribution; and
the natural graphite in the second active material layer has a monomodal particle size distribution.

5. A negative electrode for a non-aqueous electrolyte secondary battery, the negative electrode comprising:
a collector;
a first active material layer;
a binder layer; and
a second active material layer, in this order, wherein:
each of the first active material layer and the second active material layer contains a negative electrode active material and a binder;
a mass fraction of the binder in the binder layer is higher than a mass fraction of the binder in the first active material layer and the second active material layer;
the negative electrode active material in the second active material layer substantially consists of natural graphite and an Si-based active material;
the negative electrode active material in the first active material layer substantially consists of the natural graphite;
the natural graphite in the first active material layer has a bimodal particle size distribution;
the natural graphite in the second active material layer has a monomodal particle size distribution;
an alignment angle of the natural graphite in the second active material layer is larger than an alignment angle of the natural graphite in the first active material layer; and
the alignment angle indicates an acute angle between a major axis diameter of the natural graphite and a surface of the collector.
